(19) United States
(12) Patent Application Publication
(10) Pub. No.: US 2019/0029250 A1
(43) Pub. Date: Jan. 31, 2019

(54) Preventing and destroying Citrus Greening and Citrus Canker using Rhamnolipid

(71) Applicant: Keith DeSanto, St Petersburg, FL (US)

(72) Inventor: Keith DeSanto, St Petersburg, FL (US)

(21) Appl. No.: 15/899,873

(22) Filed: Feb. 20, 2018

Related U.S. Application Data
(60) Provisional application No. 62/521,616, filed on Jun. 19, 2017.

(51) Int. Cl. A01N 25/30; A21D 2/14; A01N 43/16; A01N 63/02

(52) U.S. Cl. CPC A01N 25/30; A01N 63/02; A01N 43/16; A21D 2/14

(57) ABSTRACT

This new Rhamnolipid discovery eliminates disease in plants and trees by breaking down the cells walls of bacteria such as Candidatus Liberibacter asiaticus also known as the Huanglongbing “HLB” yellow dragon disease, and Xanthomonas Axonopodis.

Because Rhamnolipid has both hydrophilic and hydrophobic components, Rhamnolipid facilitates its entry into cell membranes by breaking down the cell wall of bacteria. Bacteria Cell permeability is created by using this application.

Citrus Greening and Citrus Canker are diseases caused by bacteria. Citrus Greening also known as the Huanglongbing disease (abbreviated as HLB), or Yellow Dragon Disease is caused by the bacteria Candidatus Liberibacter also known as Candidatus Liberibacter asiaticus. Citrus Canker is also a bacterial disease caused by the bacteria Xanthomonas axonopodis. Citrus Greening and Citrus Canker are diseases that affect citrus trees and may also be found on non-citrus trees, plants and bushes. These diseases by way of the bacteria are transferred by pests, wind, rain and farming tools.

This new Rhamnolipid discovery eliminates disease in plants and trees by breaking down the cells walls of bacteria such as Candidatus Liberibacter asiaticus and Xanthomonas Axonopodis.

Citrus Greening and Citrus Canker are diseases caused by bacteria. Citrus Greening also known as the Huanglongbing disease (abbreviated as HLB), or Yellow Dragon Disease is caused by the bacteria Candidatus Liberibacter also known as Candidatus Liberibacter asiaticus. Citrus Canker is also a bacterial disease caused by the bacteria Xanthomonas axonopodis. Citrus Greening and Citrus Canker are diseases that affect citrus trees and may also be found on non-citrus trees, plants and bushes. These diseases by way of the bacteria are transferred by pests, wind, rain and farming tools.

Because Rhamnolipid has both hydrophilic and hydrophobic components, Rhamnolipid facilitates its entry into cell membranes by breaking down the cell wall of bacteria. Bacteria Cell permeability is created by using this application.

Rhamnolipids are one of the most important biosurfactant types (Haba et al., 2013) and are mainly produced by the fermentation rote of Pseudomonas aeruginosa, but they also can be produced by Rhodotorula taiwanensis, Lactobacillus Plantarum, Pseudomonas Rhizophila, Pseudomonas Chlororaphis and Burkholderia sp. They are recognized as a “green production” due to their low environmental cytotoxicity, but they also have high emulsification potential and antimicrobial activities. The two components of Rhamnolipid consist of a hydrophilic (water attracting) part and a hydrophobic (water hating) part. Because rhamnolipid is amphipathic (having both hydrophilic and hydrophobic parts), this characteristic makes it easy to penetrate cell membranes of bacteria that cause disease.

### Rhamnolipid Production

The production medium consisted of a Ca-free mineral salt solution with 15.0 g/L NaNO3, 0.5 g/L MgSO4×H2O, 1.0 g/L KCl and as a phosphate source 0.3 g/L K2HPO4. As sole carbon source soybean oil with a starting concentration of 250 g/L was used and 1 mL/L of the above-mentioned trace element solution was added.

The trace element solution contained 2.0 g/L sodium citrate×2 H2O, 0.28 g/L FeCl3×6 H2O, 1.4 g/L ZnSO4×7 H2O, 1.2 g/L CoCl2×6 H2O, 1.2 g/L CuSO4×5 H2O, and 0.8 g/L MnSO4×H2O. The fermentation was carried out at 37° C., pH 6.9, and the process was carried out for 158 h. The rhamnolipid produced was purified by acidification and then an extraction was carried out using ethyl acetate.

The molecular weight of the rhamnolipid is between 475 g/mol and 677 g/mol.

Because Rhamnolipid has both hydrophilic and hydrophobic components, Rhamnolipid facilitates its entry into cell membranes by breaking down the cell wall of bacteria Candidatus Liberibacter asiaticus and Xanthomonas Axonopodis. Cell permeability of the bacteria is created by using this application.

1. Injecting rhamnolipid by use of capsule into the stem or root of a plant, a bush or a tree to cure diseases.

2. Injecting rhamnolipid by use of capsule into the stem or root of a plant, a bush or a tree to cure it of the disease called Citrus Greening.

3. Injecting rhamnolipid by use of capsule into the stem or root of a plant, a bush or a tree to cure it of the disease called Citrus Canker.

4. Injecting rhamnolipid by use of capsule into the stem or root of a plant, a bush or a tree to cure it of the disease called Citrus Blackspot.

5. Using claim 1, preventing the growth of bacteria, fungus, or oomycota in a plant, bush or tree.

6. Using rhamnolipid in claims 1 through 5 whereas the rhamnolipid consists of a combination of mono-rhamnolipid and di-rhamnolipid with the molecular weight of the rhamnolipid between 475 g/mol and 677 g/mol.

7. Using claims 1 through 6 where the Rhamnolipid is in powered form.

8. Using claims 1 through 6 where the Rhamnolipid is in aqueous form.

9. Using rhamnolipid in claims 1 through 8 whereas the purity of rhamnolipid is 0.0001 percent to 75 percent depending on the type of bacteria that the application is treating.

10. Using rhamnolipid in claims 1 through 9 whereas the carrier for the rhamnolipid is a liposome.

11. Using claim 1 where a peptide encapsulated in a Rhamnolipid Liposome is injected in the stem or root of a plant or tree to eliminate Citrus Greening and Citrus Canker.

12. Using claims 1 through 11 where the application breaks down the wall of the bacterium Xanthomonas axonopodis to eradicate citrus canker in plants, bushes and trees.

13. Using claims 1 through 11 to kill the bacterium Xanthomonas axonopodis to eradicate citrus canker effecting plants, bushes and trees.

14. Using claims 11 and 13 to prevent citrus canker.

15. Using claims 1 through 11 where the application breaks down the wall of Candidatus Liberibacter asiaticus bacteria, known as the Huanglongbing (HLB) disease to destroy citrus greening in plants bushes and trees.

16. Using claims 1 through 11 to kill the bacterium Candidatus Liberibacter asiaticus, known as the Huanglongbing (HLB) disease to eradicate citrus greening effecting plants, bushes and trees.

17. Using claims 1 through 11 to prevent citrus greening.

19. Using claims 1 through 15 to prevent Citrus Greening from spreading to other plants trees, and surfaces.

20. Using claims 1 through 15 to prevent Citrus Canker from spreading to other plants trees, and surfaces.
